(19) United States
(12) Patent Application Publication
(10) Pub. No.: US 2010/0313690 A1
(43) Pub. Date: Dec. 16, 2010

(54) Piece of Furniture Such as a Bed or a Chair

(75) Inventors: Jens Jørgen Nielsen, Broager (DK); Kurt Lorenzen, Broager (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: LINAK A/S

(21) Appl. No.: 12/223,931

(22) PCT Filed: Feb. 15, 2007
(86) PCT No.: PCT/DK2007/000073

§ 371 Date: Aug. 13, 2008

(30) Foreign Application Priority Data
Feb. 17, 2006 (DK) PA 2006 00226

(51) Int. Cl. F16H 21/44

(52) U.S. Cl. 74/102

(57) ABSTRACT

A piece of furniture such as a bed or a chair, with an adjustable section (2, 3) adjustable about a pivot shaft (4) embedded in a frame (1). A claw shaped arm (5) intended for engagement with a spindle nut constructed as a sliding element in a linear drive is secured to the shaft (4) for adjustment of the section. The claw shaped arm (5) is with a simple punching and bending process made from a plate material. A correct mutual position of the two legs (13a, 13b) of the arm is obtained, as possibility for a good and stable fixing of the arm (5) on the pivot shaft (4) is achieve.

The present invention relates to a piece of furniture such as a bed or a chair, as stated in the preamble of claim 1.

For explanation of the invention reference is made to WO 03/04 5195 A1 Cimosys Limited which deals with a bed with an adjustable backrest and legrest section embedded in a frame. For elevating the backrest section in a pivoting manner there is a transverse pivot shaft embedded in the frame, said pivot shaft has at each end a lever which with an end engages the backrest section. In a similar manner there is a pivot shaft and lever for moving the legrest section. A drive unit with a linear drive at each end is mounted on the two pivot shafts. Said linear drives have a spindle with a nut designed as a sliding element. The sliding elements being engaged with a short arm secured to the respective pivot shafts. The arm is claw shaped and sits astride the spindle facing an end of the sliding element. Traditionally, the arm consists of two individual plate elements separately welded onto the pivot shaft at a certain mutual distance, cf. for example U.S. Pat. No. 6,300,732 B1 Compact srl. It is decisive for the function that the two plate elements of the arm are placed in a correct angle and distance on the shaft and with a correct mutual distance between them. This question is among other things the object for DE 203 15 919 U1 Standswerk Wetter Sichelschmidt GmbH & Co. KG, in which a distance part is inserted between the two plate elements in order to ensure the correct mutual distance. Subsequently, Standswerk Wetter Sichelschmidt GmbH & Co. KG has suggested in DE 203 09 044 U1 to construct the claw shaped arm as a forged part, which is rather demanding. A further issue is also a robust and rigid fixing of the arms to the pivot shafts as the arms are heavy loaded.

The object of the invention is to provide a claw shaped arm which combines a robust and rigid fixing with a simple and inexpensive manufacturing and further provides in an easy manner a correct location of the arm.

This is achieved according to the invention with an embodiment as stated in claim 1, in which the claw shaped arm is as a single component cut out and bent from a plate material. This is a simple and inexpensive manufacturing method, which simultaneously provides a possibility for a good welding onto the shaft. At the same time a correct distance between the two legs of the claw shaped arm is ensured.

In a preferred embodiment there is in the upper end of claw shaped arm a notch for receiving the pivot shaft which makes it easy to place it on the pivot shaft. Preferably the notch is semicircular corresponding to the outer diameter of the pivot shaft having the additional advantage of a long contact surface providing good basis for a stable fixing to the pivot shaft. In a further embodiment the upper part of the claw shaped arm has a rectilinear plate running parallel to the pivot shaft which presents an alternative for fixing the claw shaped arm to the pivot shaft. When the notch or notches are so deep and situated so that the rectilinear plate element abuts the shaft this provides an additional possibility for fixing the claw shaped arm to the pivot shaft.

To make the upper part of the claw shaped arm rigid the side members from which the legs stretches out could have a side flap bend towards each other. Also having the rectilinear plate element the flaps are running parallel to this. Further rigidity could be obtained by that the ends of the two flaps joints and are welded together.

In a further preferred embodiment the legs of the claw shaped arm are hardened which minimizes wear from the engagement with the sliding element whereas the upper part is not hardened which makes the welding easier.

An embodiment of the invention will be explained in greater detail in the following with reference to the accompanying drawing, in which:

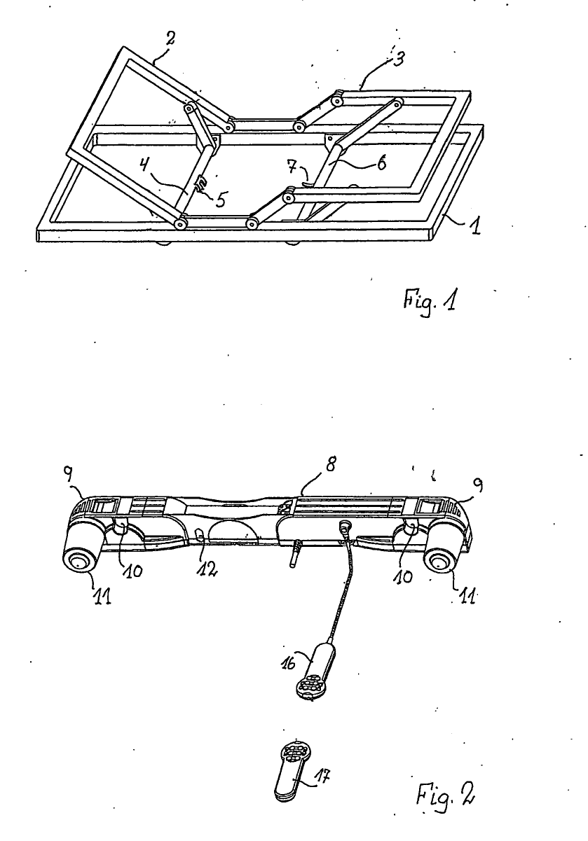

FIG. 1, shows a slatted bed with raised backrest and legrest section,

FIG. 2, shows a perspective view of a dual actuator,

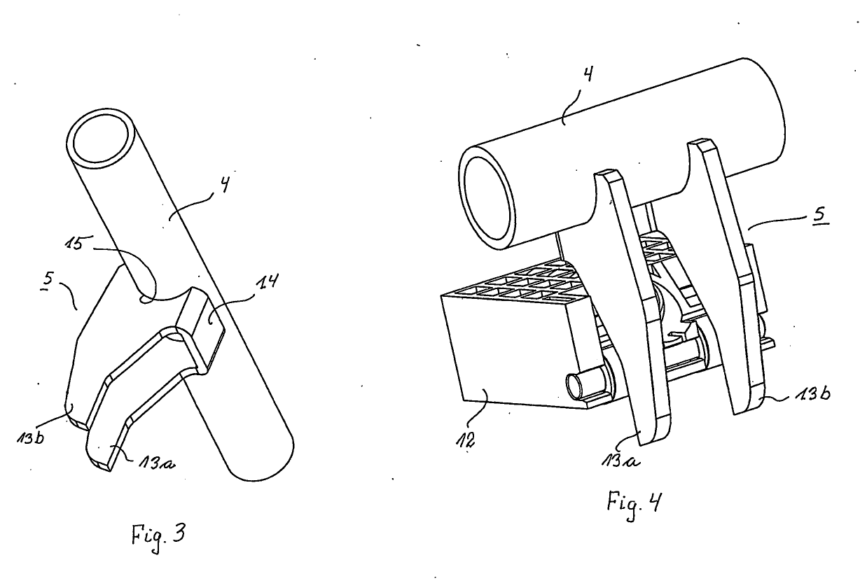

FIG. 3. shows a claw shaped arm shown perspectively mounted on a pivot shaft, and

FIG. 4, shows the claw shaped arm engaged with a spindle nut in the actuator constructed as a sliding element.

As it appears from FIG. 1 the slatted bed comprises a frame 1, in which a backrest section 2 and an articulated legrest section 3 is embedded. For the backrest section 2 a transverse pivot shaft 4 with a short arm 5 fixedly mounted onto it, is embedded in the frame. Correspondingly, there is a shaft 6 with a short arm 7 for the legrest section.

The movement of the backrest and legrest section 2, 3 is obtained with a drive unit in the nature of a dual linear actuator as shown in FIG. 2. The drive unit comprises a housing 8, with a sliding cover 9 at each end, said covers giving access to an opening 10 for the respective pivot shafts 4, 6. In connection with the shaft openings 10 there is a linear drive driven by a motor 11, mounted perpendicular to the housing. Over a worm gear, the motor drives a spindle with a spindle nut designed as a sliding element 12. The sliding element is fixed against rotation in the housing 8 and by rotation of the spindle the sliding element 12 is moved back and forth depending on the rotary direction of the spindle. As the arm 5 on the pivot shaft 4 of the backrest section engages the end of the sliding element 12, the backrest section is in a pivoting manner elevated up and down, respectively. Correspondingly, the linear drive in the other end of the drive unit operates the legrest section.

The drive unit is mounted on the slatted bed by pulling the covers 9 outwards from the end of the drive unit, and leading the drive unit in until the pivot shafts 4, 6 rest in the openings 10 and the arms 5, 7 located inside the drive unit. The covers 9 are shut again, by means of which the actuator hangs on the pivot shafts 4, 6. When the linear drives are activated, the pivot shafts are turned as the sliding elements 12 of the respective linear drives engages the arms 5, 7, which causes the backrest and the legrest section respectively to be raised or lowered.

As it appears from FIGS. 3 and 4 the arm 5 on the pivot shaft 4 of the backrest section 2 is punched and folded in one operation from a plate element as a single component. Said arm being designed as a claw with two legs 13a, 13b, connected by a interconnecting element 14 at the top. In the top part 13a, 13b of the legs there is a semicircular notch 15 for receiving the tube shaped pivot shaft 1. The claw is welded onto the pivot shaft 1 along the notch 15 and by the upper edge of the interconnection element 14.

At the opposite side of the interconnecting element 14 the legs can have two flaps, which are bend against each other, and form a corresponding interconnecting element, which for one thing helps stabilize the legs but also provides the possibility for a further welding to the shaft 4.

The arm 7 on the pivot shaft 6 of the legrest section is constructed accordingly.

Thus, with the invention a claw shaped arm is created through a simple punching and bending process, said arm can be secured to the pivot shaft in a robust and rigid manner by means of suitable welding. Further the leg portions 13a, 13b could be hardened to resist wear caused by engagement with the sliding element 12 of the drives.

Just to complete for the adjustment of the backrest and legrest sections 2, 3 the drive unit 8 could be operated by a cable connected remote control 16 as well by a IR remote control 17.

1. A piece of furniture in which an adjustable section (2, 3) is rotatable embedded in a frame (1), and in which a claw-shaped arm (5, 7) with two legs (13a, 13b) intended for engagement with a spindle nut (12) designed as a sliding element in a linear actuator is secured to a pivot shaft (4, 6) for adjusting the section (2, 3), wherein the claw-shaped arm (5, 7) as one element is cut out and bent from a plate material.

2. Furniture according to claim 1, including a notch (15) in the upper end of the claw-shaped arm for the pivot shaft (4, 6).

3. Furniture according claim 2, wherein said notch (15) is semicircular corresponding to the outer diameter of the pivot shaft (4, 6).

4. Furniture according to claim 1, wherein the upper part of the claw-shaped arm has a rectilinear plate element (14) running parallel to the pivot shaft (4, 6).

5. Furniture according to claim 4, wherein notches (15) are so deep and situated so that at least the rectilinear plate element (14) stretches parallel to and at least with the upper edge abuts the shaft (4, 6).

6. Furniture according to claim 1, wherein the upper part of the claw-shaped arm on one side has a flap bend towards each other.

7. Furniture according to claim 3, wherein the ends of the two flaps joints and are welded together.

8. Furniture according to claim 1, wherein the claw-shaped arm (5, 7) is made of steel and the legs (13a, 13b) thereof are hardened.
